(19) United States
(12) Patent Application Publication
(10) Pub. No.: US 2025/0187047 A1
(43) Pub. Date: Jun. 12, 2025

(54) SELF-PROPELLED CLEANING APPARATUS FOR LARGE DIAMETER PIPES

(71) Applicant: Conco Services LLC, Verona, PA (US)

(72) Inventors: Christian Geppert, Verona, PA (US); Stefan Schroth, Wiesbaden (DE)

(73) Assignee: Conco Services LLC, Verona, PA (US)

(21) Appl. No.: 18/533,724

(22) Filed: Dec. 8, 2023

(51) Int. Cl. B08B 9/049

(52) U.S. Cl. CPC B08B 9/0495

(57) ABSTRACT

A pipe cleaning apparatus can be used to clean and service an interior surface of a pipe. The apparatus has cleaning nozzle that spray the interior surface of the pipe as they rotate around a central axis. Drive wheels allow the apparatus to traverse the pipe in a longitudinal direction. Further, guide wheels keep the apparatus positioned within the pipe. Adjustable mechanisms allow the wheels to adapt to different size pipes. A drive shaft, air motor, and worm gears coordinate the movement of the apparatus to the speed of the cleaning nozzles, which varies depending on the diameter of the pipe.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention relates generally to the field of cleaning apparatus for large diameter pipes and more particularly to such an apparatus which uses a basic structure for cleaning pipes with spray arms and circulating high pressure nozzles, but which is expandable for use in a wide range of diameters of pipes. The present invention further relies on an automatic synchronization of the travel of the nozzles in tangential and advancing directions.

In various applications the insides of large pipelines have deposits or damaged protective liners which have to be removed periodically. Cleaning jets exiting rotating nozzles should remove deposits from the pipeline wall and flush debris away. Therefore, it is beneficial for the traces of the cleaning jets to overlap in order to generate a homogeneously clean surface.

European Patent No. EP 2 139 621 B1 discloses a self-propelled cleaning apparatus with opposite driving wheels and with opposite guiding wheels, which are expandable for a limited range of pipe diameter. The expansion of the wheels to fit different diameter pipes is limited by the length of movable parallel supporting arms and by the stroke of attached cylinders, which are individual to each wheel. In the frontal region of the apparatus a high-pressure water feeding hose feeds into a high pressure coupling to a rotating hollow shaft with two spray arms and thereon attached spay nozzles. Rotation is achieved by an air motor, which with a driving belt drives simultaneously the hollow shaft and one of the driving wheels via a chain of cardan shafts. Further driving wheels have individual air motors, which drive the wheel via a worm gear for developing higher and more equally distributed pulling forces. So, there are two different air driven systems, which must care for a simultaneous advance movement at opposed driving wheels. The ratio between circumferential speed of the nozzles and advance movement should be kept constant for improved cleaning results. When the system is enlarged to a larger pipe diameter, the nozzles with elongated nozzle arms would cut at a higher circumferential speed and therefore the rotational speed and the advance speed of all air driven wheels should be lowered. Furthermore, some driving wheels run at the deepest bottom of the pipe, where the cut away debris is assembling. It would therefore be advantageous to develop a cleaning apparatus that is adjustable to different size pipes and maintains proper speed at the wheels and cleaning nozzle.

### BRIEF SUMMARY

It is the aim of the invention to create an effective pipe cleaning apparatus for large pipe diameters and long pipes, which apparatus is functional safe, whereby a basic apparatus can be easily modified for larger pipe diameters.

With the choice of one main single air motor attached to a worm gear, which drives a central hollow shaft with one driving sprocket and with the choice of equal driving sprockets on the hollow shaft driving with equal roller chains identical off-the shelf worm gears, which drive with equal sprocket gears identical driving wheels, a simultaneous advance movement is mechanically achieved. And with a pressure wheel situated between the forward and the rear driving wheels on the top of the apparatus, enough pressure is achieved at the driving wheels to prevent their slipping.

With the reduced speed in the kinematic chain to the driving wheels the transferred torque moments and bearing forces increase. This fact is covered by the know how in the off-the-shelf worm gears and by a heavy structure of the driving wheels frames. Therefore, in the last transmission from the worm gear to the driving wheel the output sprocket of the worm gear has a small diameter, whereas the diameter of the driving wheel sprocket is close to the diameter of the driving wheel.

The worm gears attached on the left side of the angles are identical with the worm gears at the right side of the angles. When left side worm gears would be turned by 180 degrees for fixation at the right side, the attached driving wheels would drive in the opposite direction. But seen from this side the hollow shaft turns in opposite direction and turns the driving wheel in the same direction as on the left side. With this arrangement the structure becomes compact, there is space for the roller chains and all worm gears for the driving wheels are identical. Thus, the mechanically synchronized drives result in a constant and precise cleaning track and regardless of power supply fluctuations the cleaning track geometry will not be influenced. Operators will only have to adjust the speed of the single drive motor for adapting the jet cleaning abilities to the type of debris/pipe-coating that needs to be removed.

The off-the-shelf worm gear boxes for all wheel drives are identical in housing dimensions and extended shaft ends. They are available with various gear ratios allowing pitch changes of the spiral shaped cleaning track by simply swapping the worm gear boxes. Using driving wheels with a diameter of 10″, a chain drive transmission ratio of 1:2 between the wheels and the output shafts of the wheel-drive worm gear boxes, a transmission ratio of 1:30 between the output shaft and input shaft of the wheel-drive worm gear boxes, a chain drive transmission ratio of 1 between the input shafts of the wheel-drive worm gear boxes and the hollow drive shaft, the resulting pitch of the spiral, that the cleaning jet track of a single cleaning nozzle moved by the rotor head would generate on the pipe wall, would be slightly larger than 0.5″ (0.524″). Fitting the rotor head with two opposing cleaning nozzles would result in cleaning jet tracks with 0.25″ between two adjacent tracks. The rotational speed of the hollow drive shaft and thus for the rotor head would be adjusted for a suitable cleaning jet travel velocity across the pipe surface for obtaining best cleaning results.

By maintaining the wheel diameter and these transmission ratios, the same spiral pitch will result on the pipe wall regardless of pipe diameter.

It is another advantage that all worm gears driving the driving wheels are equal in output speed, when the transmissions from the sprocket gears of the hollow shaft to input sprockets gears of the worm gears are the same with the same distance of the shafts. For enlarged applications with spacer elements it makes it easy to install between the hollow shaft and the worm gears a further shaft with a 1:1 transmission and maintaining the main components without changing the speed of the driving wheels. As the speed reduction is stepwise to lower speeds there are no problems with critical speeds for the involved shafts.

It is a further advantage for the stability of the apparatus when the pressure wheel on the top gets an additional worm gear for acting as a driving wheel. Nevertheless, for the stability of highly, by spacer elements, enlarged applications with a growing distance of the pressure wheel to the constant distance between forward and rear driving wheels, the drag of supply hoses and smaller obstacles might move the frontal part of the apparatus upwards, the frontal driving wheels might loosen contact to the pipe wall, and the rear driving wheels might be still in action. Therefore, for limiting the inclination a further anti-tilt guiding wheel is installed at a small distance to the pipe wall on the top of the forward casing.

In some parts the hollow shaft comprises two concentric shafts, an inside tube for the transport of pressurized liquid and an outer driving shaft, where the shaft pieces are assembled with bearings and driving sprockets. As the forward and the rear angles consist of bolted on metal sheets, those sheets taking the bearings can be assembled with the bearings and with the driving sprockets by slipping these sidewards in the right followed by the penetrating outer shaft on a mounting frame and fixing them with clamping rings and keys. Later the inside tube prevents leakage of the pressurized liquid.

As mentioned above the constant speed ratio of all driving wheels to the hollow shaft, which rotates the feeding tubes and spray nozzles, allows it to produce the same cleaning trace for the nozzles at all pipe diameters. In order to achieve the required tangential speed of the rotating nozzles, which brings desired cleaning results, the speed of the single air motor must be adapted for each pipe diameter. Therefore, the supply of compressed air consists of two hoses for controlling the speed of the hollow shaft from the entrance of the pipe. The hoses also deliver compressed air to a buffer tank on the apparatus, which is connected to two cylinders spreading the pressure wheel.

Cleaning results are improved by maintaining a constant distance between cleaning jet exit at the spray nozzle and the pipe wall. The spray nozzle assembly of each rotor arm can comprise the spray nozzle with its high-pressure fluid flow connector installed on the same articulating spring-loaded lever as the guide wheel. Since the guide wheel is continuously pressed against the pipe wall by the spring-loaded lever, the spray nozzle will be moved across the wall at constant distance. The spring-loaded lever is either directly connected to a spring and the force between the guide wheel and pipe wall corresponds to the spring force multiplied by the lever ratio of the distance between the hinge point of the arm and the spring attachment point and the distance between the hinge attachment point and the wheel-to-wall contact point. Or alternatively a parallelogram linkage is fitted between the spring attachment point and the spray lever assembly. The spray lever assembly is attached to the rotor arm, which is solidly coupled to the rotor head. The above rotor arm structure would also fit to other cleaning apparatus like the one cited in European Patent No. EP 2 139 621 B1.

### BRIEF DESCRIPTION OF THE SEVERAL VIEWS OF THE DRAWINGS

So that the manner in which the above recited features, advantages and objects of the present invention, briefly summarized above, may be had by reference to the embodiments thereof which are illustrated in the appended drawings.

FIG. 1 is a side view of a basic cleaning apparatus of this invention, shown in a pipe during cleaning.

FIG. 2 shows how driving wheel frames fit into center angles.

FIG. 3 is a side view of an assembled driving wheel frame and its corresponding worm gear.

FIG. 4 is a section of the assembled wheel frame in FIG. 3.

FIG. 5 is a side view of a swing arm assembly with a pressure and driving wheel with a corresponding worm gear.

FIG. 6 shows a partial section through the worm gear of FIG. 5 with the mounted swing arm.

FIG. 7 shows structural enforcements “swivel hold” and “hose pull solid”.

FIG. 8 shows a structural enforcement “cylinder hold”.

FIG. 9 shows a structural enforcement by an air tank.

FIG. 10 is a section of FIG. 1 showing the inside relations of the apparatus.

FIG. 11 is an enlarged rear end of the section of FIG. 10, showing the main worm gear and the single air motor.

FIG. 12 shows spray nozzles, rotor arm and rotor head coupled to the rotor shaft.

FIG. 13 shows a drive rotor with the single air motor, main worm gear and driving sprockets.

FIG. 14 is a section of FIG. 13.

FIG. 15 shows spacer elements for enlargement.

FIG. 16 is a side view of an enlarged cleaning apparatus of FIG. 1 with spacers (see FIG. 15) and with a replacing drive and rotor shaft and with the former driving shaft, which is further acting with longer roller chains.

FIG. 17 is a side view of the replacing drive and rotor shaft and of the former driving shaft with the arrangement of the sprockets there on.

FIG. 18 is a schematic picture of the pneumatic elements in the apparatus and of the pneumatic elements at a remote control.

FIG. 19 is a view in advance direction of the apparatus showing a rotor arm with a spring-loaded guiding wheel holding the spray nozzle at practically constant distance to the pipe wall.

FIG. 20 is a partial cross section of FIG. 19 showing the attachment of the rotor arm structure to the rotor head.

FIG. 21 is a view in advance direction of the apparatus showing a rotor arm with a spring-loaded guiding wheel and a parallelogram structure holding the spray nozzle at practically constant distance to the pipe wall.

FIG. 22 shows a method of using a launching jig.

### DETAILED DESCRIPTION

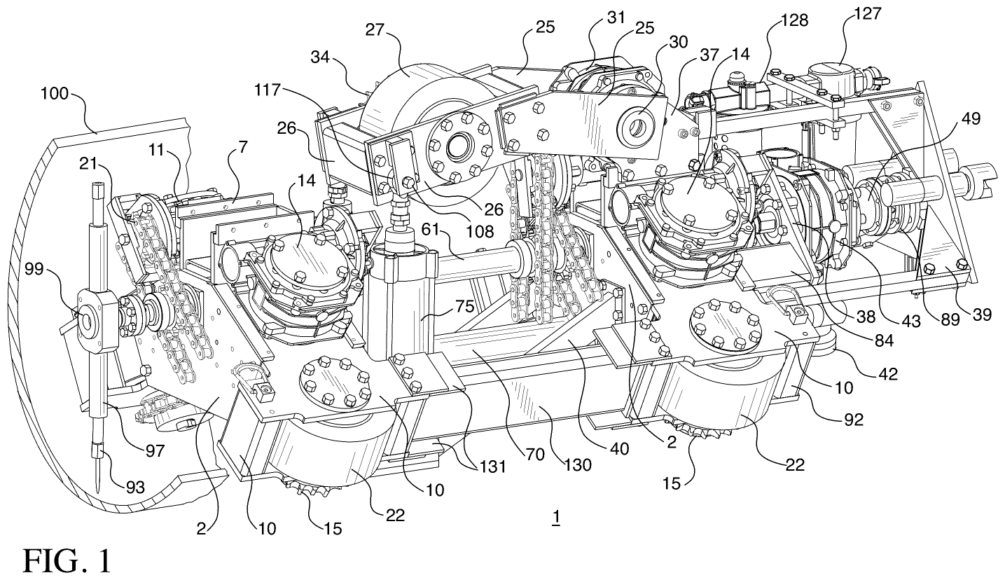

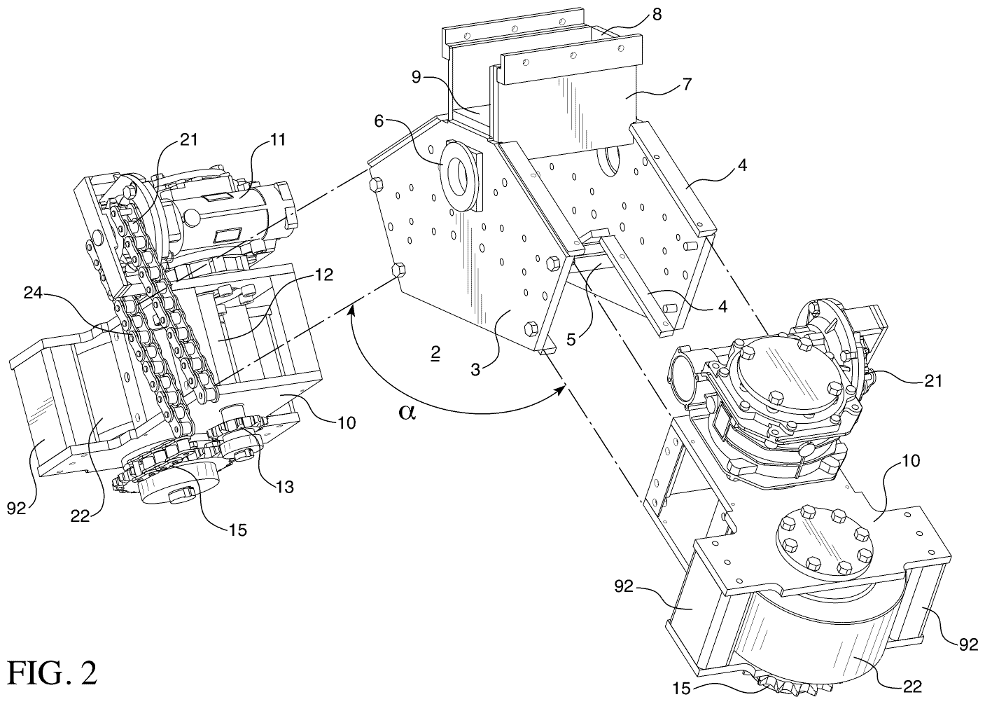

For the basic cleaning apparatus 1 in FIG. 1, the assembly is started by connecting wheel frames 10 for each side by a drive coupling 130 and brackets 131 and fixing the wheel frames 10 to the forward and rear center angles 2 at an angle α (see FIG. 2) for building a vehicle with the two wheels 22 on each side in a line. Structural pieces like swivel hold 38, hose pull solid 39, cylinder hold 40 and air tank 70 are added.

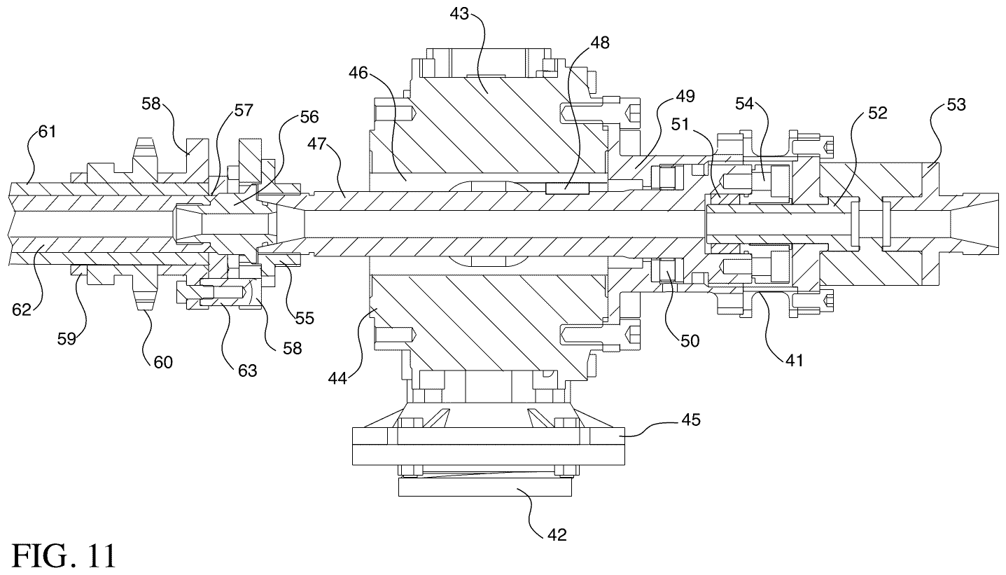

A hollow basic drive shaft 61 penetrates the two center angles 2 at bearing flanges 6 (see FIG. 2). The intermediate bearings, sprockets, spacers, and clamping rings slide on the basic drive shaft, where they can be secured for rotation by inserted keys. A single air motor 42 is directly coupled with a main worm gear 43, which is fixed to the swivel hold 38 and which is bearing and driving with a hollow shaft piece 46 of its driving gear a swivel shaft 47 (see FIG. 11).

The forward and rear center angles 2 shown in FIG. 2 comprise side walls 3 held together by a support 7 for an upper worm gear holding frame 37 and by stiffening side walls 5, 8, 9. The central angles have rails 4 for fixing the welded wheel frames 10, which give the final component stability. The stiffness is achieved by welded in rectangular tubes 92. The corresponding worm gears 11 are attached to the wheel frames 10 by screws at the output side and are coupled there with a prolongated shaft 12 and a driving sprocket 13, which drives the input sprocket 15 of the wheel 22. FIG. 2 also shows the input sprocket 21 of the worm gear 11 and the roller chain 24 coming from the drive shaft 61.

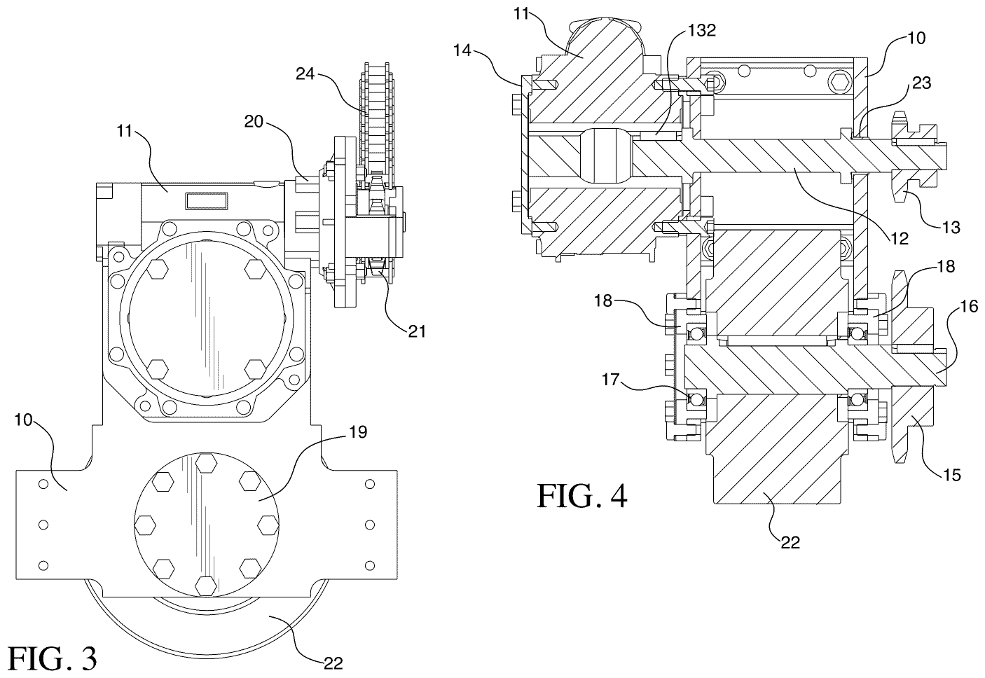

More details can be seen in FIG. 3 and FIG. 4, where the prolongated shaft 12 is held and secured by a key 132 in the hollow shaft of the output gear of the worm gear 11 and is also supported by a friction bearing 23 in the wheel frame 10. Wheel bearings 17 attached by bearing supports 18 take a wheel shaft 16 and the wheel driving sprocket 15. A gear box lid 14 gives access to the output gear of the worm gear 11.

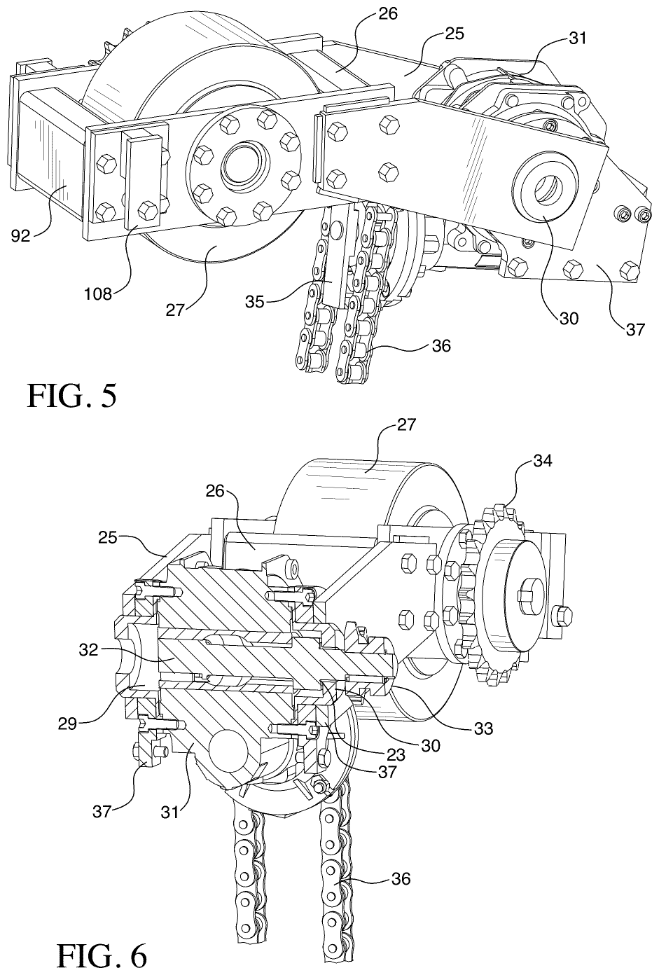

In FIGS. 5 and 6 the upper worm gear 31 for the pressure and driving rubber wheel 27 is attached to the worm gear holding frame 37 and is clamping arm hinges 29 and 30, which are screwed to the wheel frame 26. The output shaft 32 of the upper worm gear 31 is elongated and suspended from a friction bearing 23 for carrying the load at the output sprocket 33 coming from the wheel sprocket 34. The input sprocket 35 is driven by a roller chain 36 coming from the basic drive shaft 61. The welded wheel frame 26 is also reinforced by rectangular tubes 92.

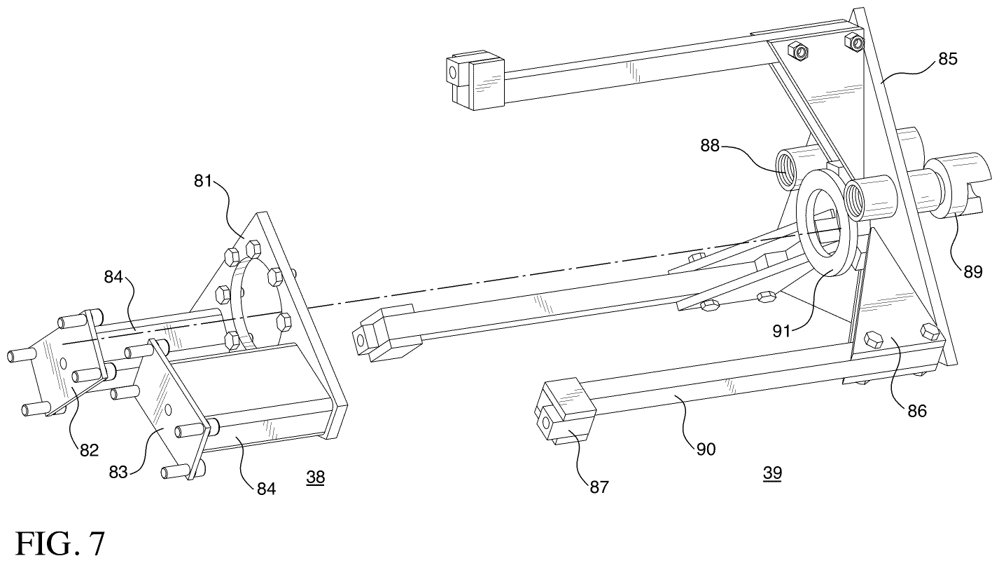

The hose pull solid 39 in FIG. 7 has a base plate 85 with welded on enforcing plates 86 and outriggers 90 screwed to the enforcing plates 86, the upper one connected to the worm gear holding frame 37 and the lower two connected by connections 87 to the wheel frames 10 (see FIG. 1). The upper outrigger 90 is also carrying a water separator 127 and an air lubricator 128, which serve for maintaining continuous working conditions. FIG. 7 shows also swivel hold 38 with a base plate 81 to be screwed to the flange 44 of the main worm gear 43 and to be screwed with connecting plates 82 and 83 to a side wall 3 of the rear center angle 2. The plates 82 and 83 are combined by welded in rectangular tubes 84.

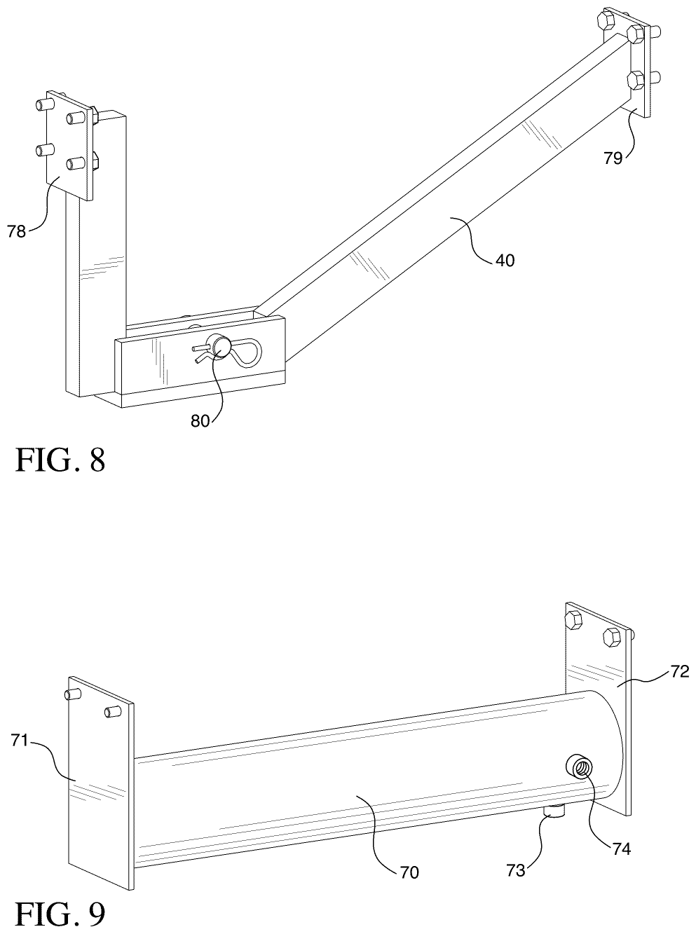

When the swing arm 25 with the rubber wheel 27 has been installed, the two spreading cylinders 75 are introduced between the cylinder hold with pivot 80 and a clamping bracket 108 (see FIG. 8) for the rod eye coupling 117 of the cylinders 75. Each spreading cylinder 75 has a cylinder hold 40 (FIG. 8), with a welded structure ending in connecting plates 78 and 79 to the inner side walls 3 of the center angles 2. A bearing pivot 80 allows angular displacement of the cylinders. Similarly, the air tank 70 (FIG. 9) comprises a tube 70 with welded on end plates 71, 72, which are attached to inner side walls 3 of the center angles 2. The tube has two pneumatic connections 73, 74.

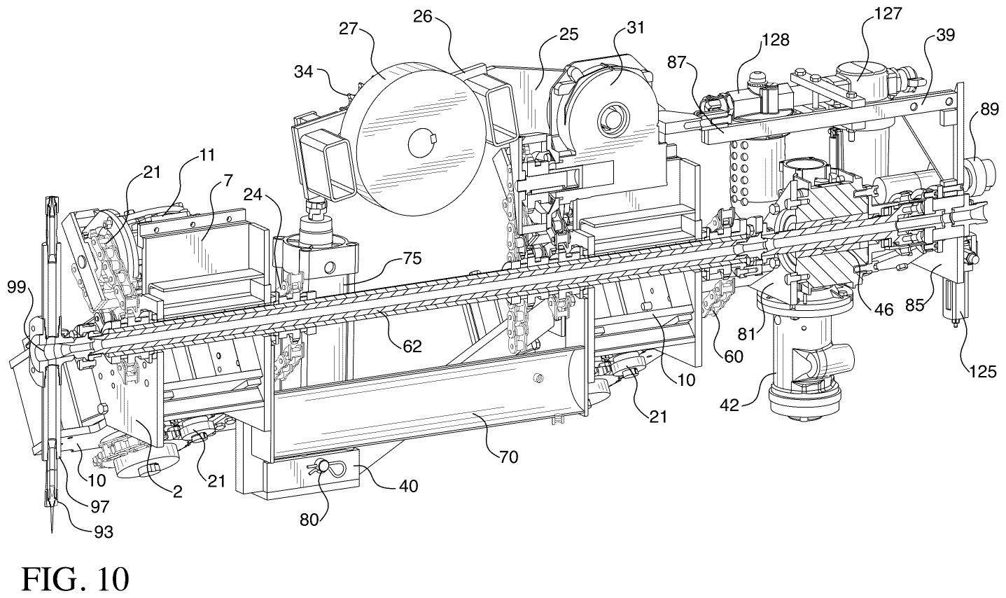

FIG. 1 and FIG. 10 show the built-in main worm gear 43 with the details shown in FIG. 11. The single air motor 42 is screwed to the main worm gear 43 at flange 45. The frontal flange 44 is connected to flange 81 of the swivel hold 38 (see FIG. 7) and the rear flange is connected to a swivel housing 49, which is connected by a cage 41 (see FIG. 11) to a swivel tube 52 and to a hose coupling 53 for the high-pressure liquid hose. A thrust roller bearing 54 takes the inside pressure at the swivel packing 51 and defines the axial position of the swivel shaft 47. The swivel shaft 47 is driven with key 48 by a hollow shaft piece 46 of the driving output of the main worm gear 43 and it is connected by a rotor shaft coupling 56 and a later applied weld 57 to the rotor shaft 62, whereas a drive shaft coupling 58 transfers the rotary movement with coupling pins 63 to the drive shaft 61 and sprocket 60.

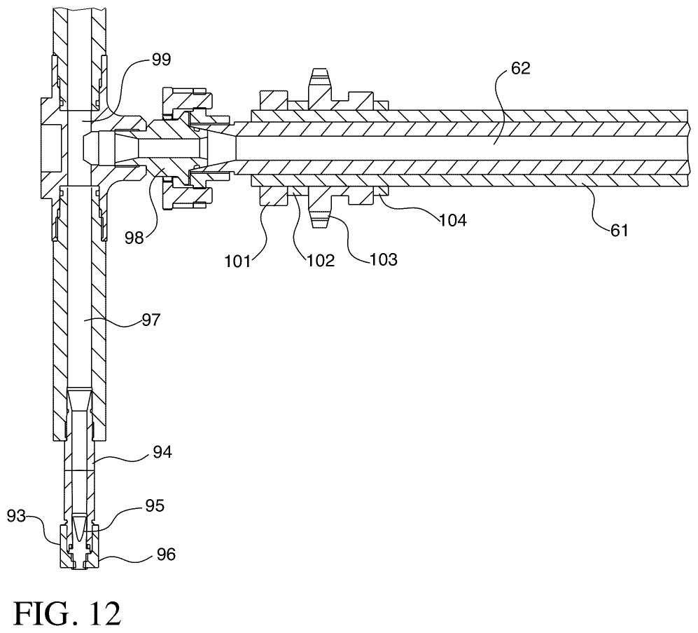

The rotor head 99, as shown with details in FIG. 12, is coupled by threads to the rotor coupling 98 and further to the rotor shaft 62. The drive shaft 61 carries a clamping collar 101, two spacers 102, 104 and a sprocket 103. The rotor arms 97 are screwed into the rotor head 99 and are connected by arm extensions 94 to jet inserts 95 and insert holders 96 of the nozzles 93.

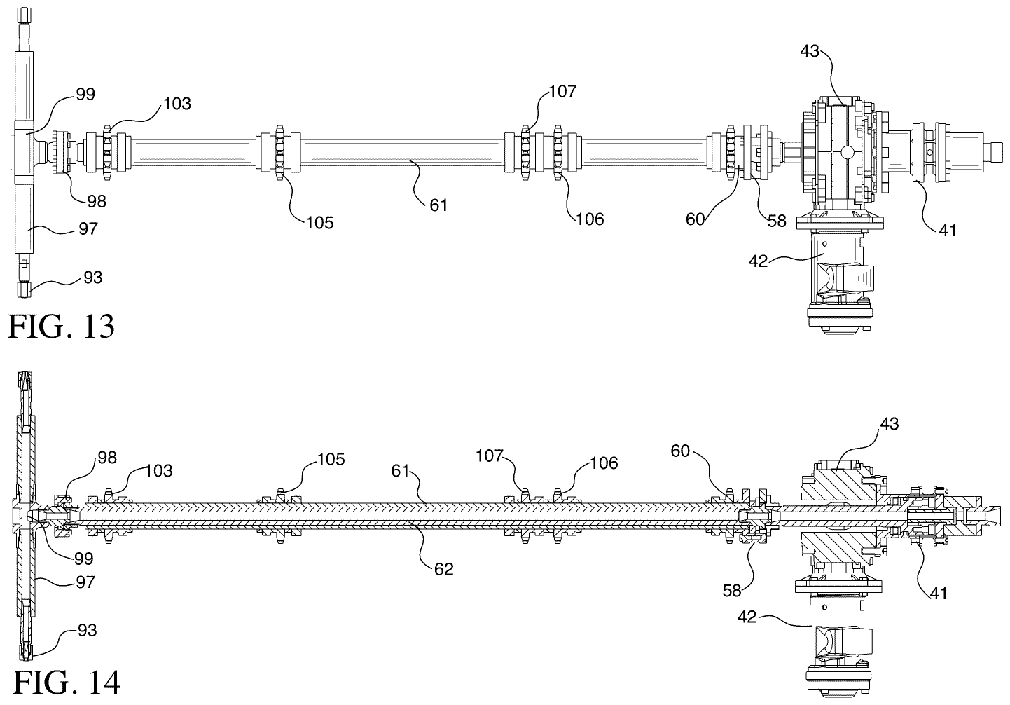

The distribution of the sprockets on the drive shaft 61 is shown in FIGS. 13 and 14. A sprocket 103 for the frontal right worm gear 11, a sprocket 105 for the frontal left worm gear 11, a sprocket 106 for the rear right worm gear 11, a sprocket 60 for the rear left worm gear 11 and a sprocket 107 for the upper worm gear 31. These sprockets (103, 105, 106, 107, and 60) drive the input sprockets of the worm gears 31 by roller chains.

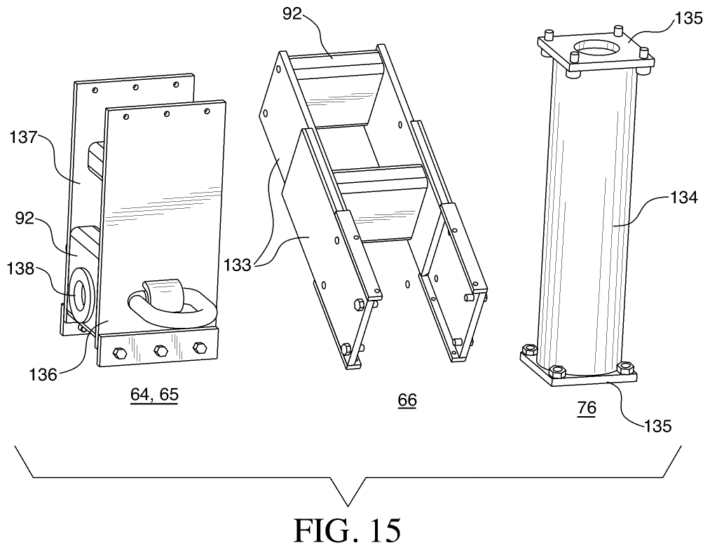

In FIG. 15 extension 65 for an ant-tilt wheel and swing arm extension 64 are equal. Their side plates 136, 137 are reinforced by rectangular tubes 92 and they have bearing flanges 138 for an extension shaft 139. The wheel unit extensions 66 have a reinforced tube 92 and expandable structure 133. And the cylinder extensions 76 consist of a tube 134 with endplates 135, whereby the lower endplate uses the pivot 80 in FIG. 8.

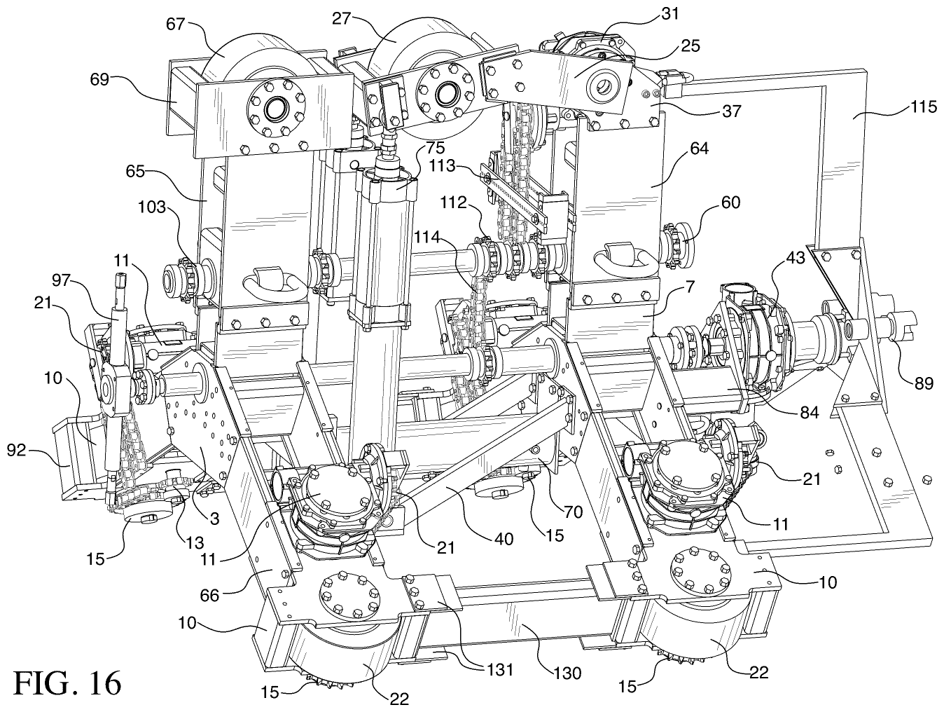

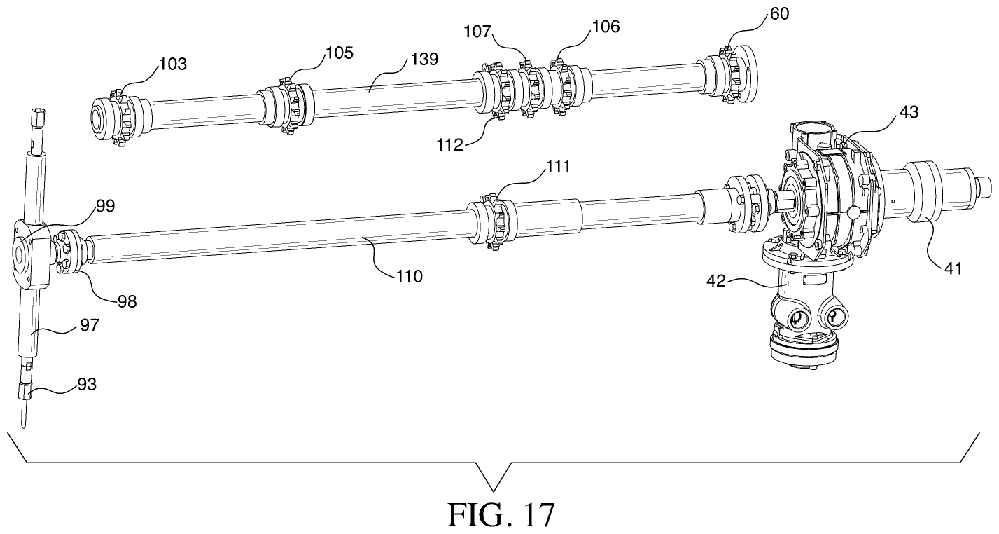

The expanded apparatus in FIG. 16 is spread by the extension elements 64, 65 and 66. It is clear, that the original rotor arms 97 are replaced by elongated rotor arms. The worm gears 11 of the driving wheels remain on the wheel frames 10 for being attached to the structure 133. The upper worm gear holding frame 37 is attached to the swing arm extension 64 and an enlarged hose pull solid 115 is fixed to the worm gear holding frame 37 and to the wheel frames 10 of the rear driving wheels 22. An expansion drive shaft 139 (see FIG. 17), which could be the original basic drive shaft 61, is carried by the bearing flanges 138 of the extensions 64 and 65 with the same distribution of the sprockets to the worm gears 11, 31 of the driving wheels 22, 27, but with longer roller chains. The expansion drive shaft has an additional sprocket 112, which is driven by sprocket 111 of a replacing drive shaft 110 in the center, consisting as well of a drive shaft 61 and a rotor shaft 62 and penetrating the center angles 2.

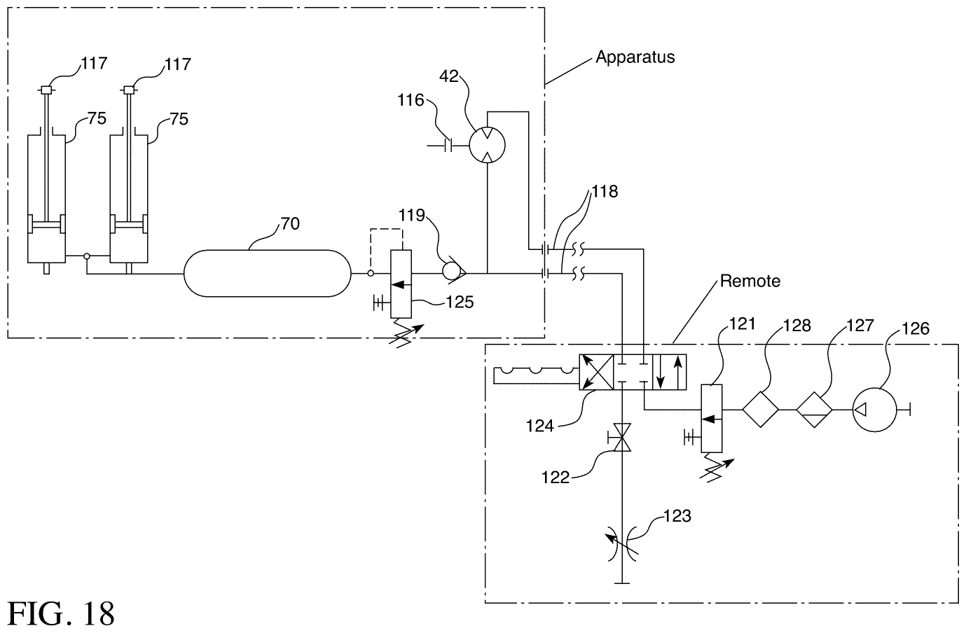

In the pneumatic diagram of FIG. 18 the apparatus 1 is coupled to two pneumatic supply hoses 118. The single air motor 42 is mechanically 116 coupled the main worm gear 43 and compressed air is delivered via check valve 119 and a pressure regulator 125 to air tank 70 which serves as buffer, when quick reactions of the cylinders 75 are required. The cylinders 75 are at their base mechanically coupled to a pivot 80 and with their rod eye assembly 117 to the swing arm. Remote control is achieved by an air compressor 126 followed by a water separator 127, an air lubricator 128, a pressure regulator 121 and a way valve 124, which is coupled with a shut-off valve 122 and a throttle valve 123 for the return flow.

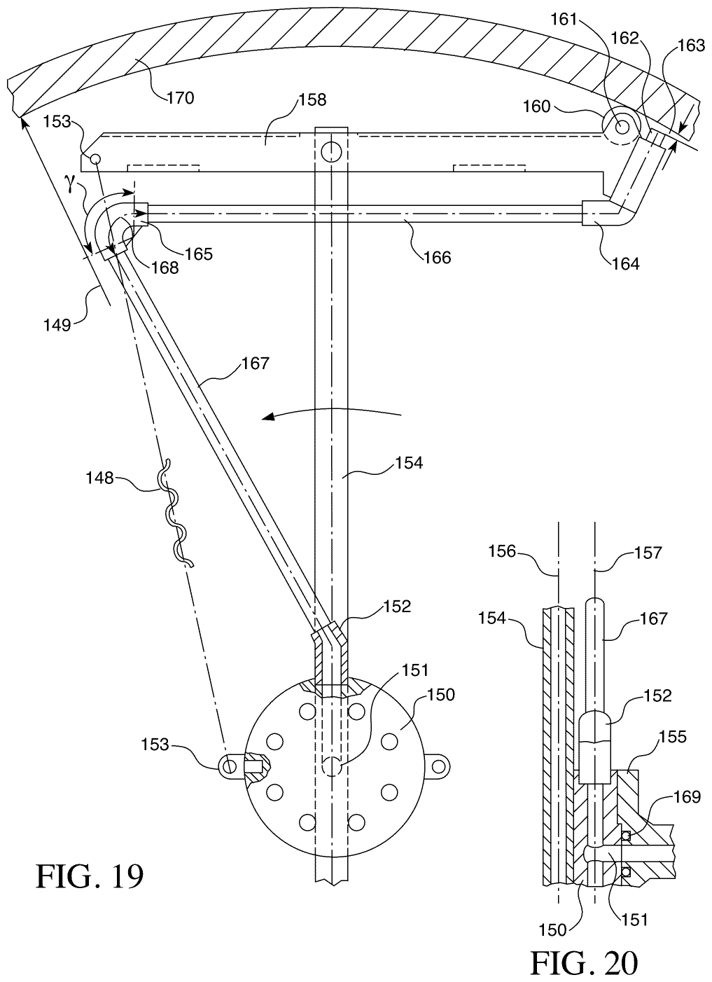

A first embodiment for individually guided nozzles 162 maintaining a constant distance 163 to the pipe wall 170 at a pipe diameter 149 is shown in FIG. 19 and FIG. 20. A connecting flange 150 bears a welded-on rotor arm 154 ending at both sides with a hinge connection 159 for a lever 158 at right angles with two arms. At one side the lever ends with a spring hold 153 for a spring 148, which is attached by a further spring hold 153 to the connecting flange. At the other end the lever is a bearing 161 and a guiding wheel 160, which is pressed against the pipe wall 170.

The guiding wheel 160 comprises metal with a rounded running surface to reduce wear. Any deviation of the guiding wheel occurs in radial direction in a first radial plane 156. The spray nozzle 162 supported by a connector 164 is attached close to the guiding wheel 160 and follows the radial displacement of the guiding wheel for maintaining a constant distance 163 to the pipe wall 170.

The liquid flow is guided in a second radial plane 157 parallel to the first radial plane 156 at a distance large enough for to have a bore to a blind hole 151 of the connecting flange and for a welded-on support 152. A seal 169 is embedded in the flange 155 and compressed by the connecting flange. The two connectors 152 and 164 are connected by a high-pressure hose 167, a diverting tube piece 165 and a second high-pressure hose 166. The diverting tube piece turns the current by an angle γ 168, whereby it is only held by the high-pressure hoses in the second radial plane 157. High-pressure hoses have an extreme torsional stiffness, and the bending radii are limited. Therefore, the hoses are kept rather long to obtain suitable bending radii and for the diverting tube piece 168 equalizing low bending moments at both sides.

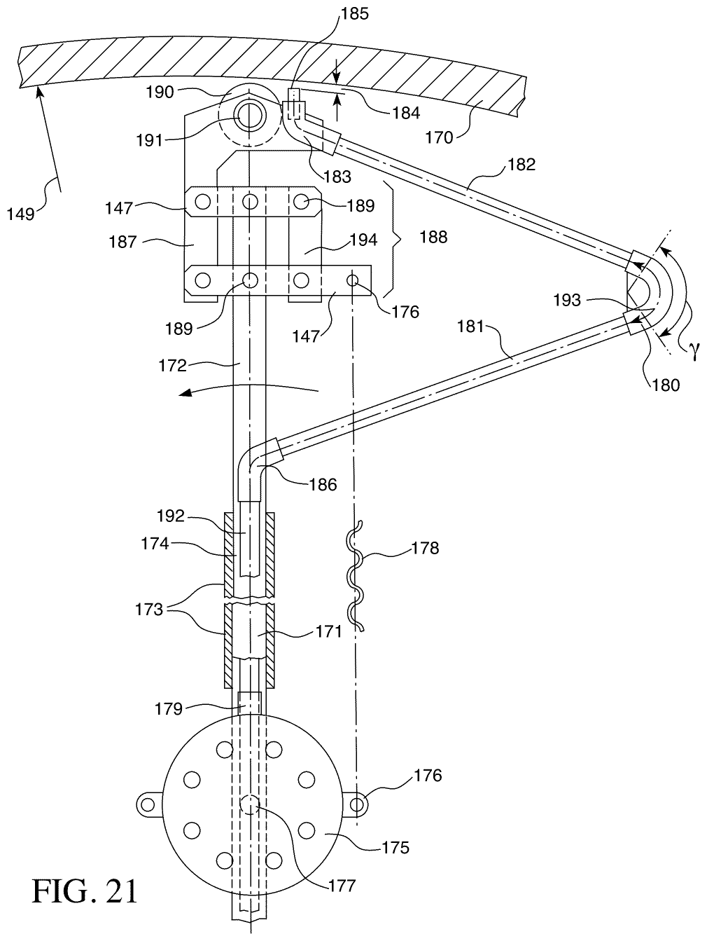

A second embodiment for an extended application of the apparatus is shown in FIG. 21. A connecting flange 175 is equal to the connecting flange 150 in FIGS. 19 and 20 connected to the flange 155. The connecting flange 175 bears at each side a welded-on interior arm piece 171, which is prolongated by an extension shaft 173 and continued by an exterior arm piece 172 and ending with a parallelogram structure 188. The structure 188 comprises an upwards pushed arm piece 187 and an opposite pulled down arm piece 194 moved by four levers 147, which are held together by bearings 189. A prolongation of a lever 147 with a spring hold 176 is used to connect a spring 178 to a second spring hold 176 at the connecting flange. A suitable spring has a flat characteristic for the growth of the spring load with increasing elongation. Thus, the small radial deviations of the guiding wheel 160 would practically cause a constant spring force for the loaded spring and for the guiding wheel 160 to the pipe wall.

The moving arm piece 187 is inclined and is holding a guiding wheel 190 with a bearing 191. It also holds a connector and nozzle support 183. The nozzle 185 is situated close to the guiding wheel 190 for maintaining a constant distance 184 to the pipe wall 170, which may have a larger diameter 149 than shown on the drawing. Equally to FIG. 19 the liquid flow is in a parallel radial plane to the radial plane of the moving nozzle 185. The flow starts at the blind hole 177 in the connecting flange 175 and continuous via a high-pressure hose 192 to a connector 186 solidly fixed at the exterior arm piece 172. From there the flow is guided into a high-pressure hose 181 followed by a diverting tube piece 180 diverting the current by an angle γ 193 into a high-pressure hose 182 and ending in the connector 183. Equally to FIG. 19 the high-pressure hoses 181, 182 enclose the diverting tube piece 180 and can compensate the radial displacement of the nozzle.

This arrangement gives the possibility to adapt the nozzles to any larger pipe diameter by exchanging the extension shaft piece 173 and the high-pressure hose 192. Due to the stiffness of the high-pressure hose 192 the latter is secured first between the connectors 179, 186 and afterwards the extension shaft 173 is definitely fixed by screws and slot holes 174 to the interior and exterior arm pieces 171, 172.

The apparatus 1 can be used in pipeline maintenance operations. For example, the apparatus can be used to remove a coal-tar coating from a 36″ pipeline. The begin the pipeline maintenance, the apparatus 1 can be launched fully assembled into the pipeline. Launching can be accomplished through port openings by excavating the area around the pipeline, then cutting and lifting out a spool piece of the pipeline.

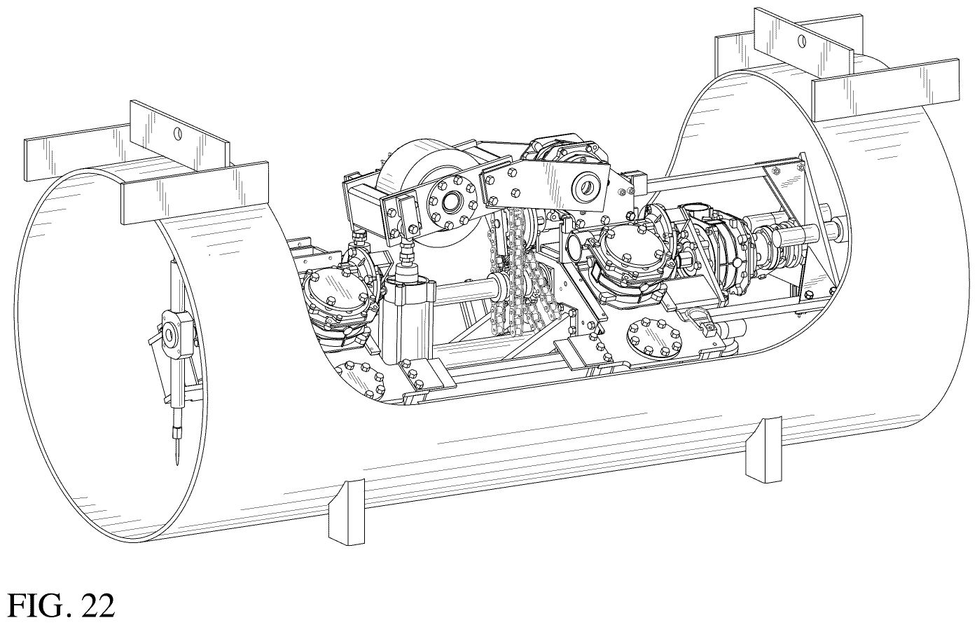

For inserting the apparatus 1 into the pipeline, hoist rings on the apparatus 1 can be used for directly moving the apparatus 1 into the pipeline or, alternatively, a launching jig can be employed to facilitate the insertion (see FIG. 22). The launching jig is a short section of pipe that has the same diameter as the pipe to be cleaned. The apparatus 1 is placed into the jig, then the opening of the jig is placed adjacent to the port opening.

A high-pressure water pump with a wastewater recycling system is positioned at the pipe entry point and an air compressor in the same vicinity is connected via supply hoses to the rear end of the apparatus 1. As the apparatus 1 begins the coal-tar coating removal process, the supply hoses are pulled into the pipeline. A feed system for the high-pressure water supply hoses is adjusted to unspool the water supply hose at a rate matching the travel speed of the apparatus 1. Compressed air hoses are similarly pulled into the pipeline at the required rate.

Upon completion of one pipeline section, the apparatus 1 is typically extracted from the full port opening at the end of this pipeline section and transferred into a full port opening of the next pipeline section. Supply hoses are pulled back to the initial starting point and together with the whole supply equipment (water supply circuit and air compressor) moved to the new entry point before being reconnected to the apparatus.

When used in this specification and claims, the terms “comprises” and “comprising” and variations thereof mean that the specified features, steps, or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure. Although certain example embodiments of the invention have been described, the scope of the appended claims is not intended to be limited solely to these embodiments. The claims are to be construed literally, purposively, and/or to encompass equivalents.

What is claimed is:

1. A cleaning apparatus for cleaning an inside surface of a large diameter pipe, the apparatus comprising:
rotating feeding tubes with spray nozzles adapted to supply pressurized cleaning liquid to the inside surface of the large diameter pipe;
a hollow shaft rotatable about a centerline of the apparatus and feeding the rotating tubes with pressurized liquid;
a coupling between an external supply hose and the hollow shaft, which takes the thrust from the external supply hose and which transfers the pressurized liquid to the hollow shaft;
a pneumatic supply hose for actuating an air motor, wherein the air motor rotates the hollow shaft;
a supporting structure, which supports the air motor, worm gears, driving wheels and pressure wheels;
worm gears reducing the speed of allocated driving wheels; and
means to transfer rotational speed from the air motor to the hollow shaft and to the driving wheels,
characterized in that the supporting structure is made of modular pieces, which can be bolted together for a basic structure, forming a forward center angle and a rear center angle, connected by a supporting structure element;
that at a bottom portion of the center angles are two driving wheels, which extend radially from the center line of the hollow shaft by an angle α and transfer the forward movement;
that at a rear side of the rear center angle α frame connects a main worm gear, which supports with its housing a single air motor, and which is part of the hollow shaft with a hollow shaft piece of a driven gear and thus acting as a bearing for the hollow shaft;
that the hollow shaft comprises a rotor shaft and a concentric drive shaft with bearings, which are slidable along the hollow shaft for assembly, and which are fixed to the forward center angle and the rear center angle;
that for each driving wheel a worm gear is attached with its housing to a wheel frame, whereby a shaft extension of the driven gear takes an output sprocket to act by a roller chain on a driving wheel input sprocket;
that the driving shaft has sprockets, which act by roller chain on input sprockets situated on an input driven shaft of the worm gear;
that each driving wheel of the driving wheels is situated in a wheel frame, which is attached to the housing of a corresponding worm gear, and which has an extending shaft end with the input sprocket;
that on the top of the apparatus, between the forward center angle and the rear center angle α pressure wheel is located, which is guided by a swing arm with hinge connections, and which is pressed radially upwards by two pneumatic cylinders to prevent slipping of the driving wheels due to missing friction; and
that the hollow shaft comprises an inside tube for the transport of the pressurized liquid and of an outer drive shaft taking assembled shaft pieces with bearings and driving sprockets.

2. The cleaning apparatus in accordance with claim 1 characterized in that the pressure wheel is also used as a driving wheel, driven with a worm gear and with sprockets and roller chains by the driving shaft.

3. The cleaning apparatus in accordance with claim 2 characterized in that the individual worm gears for the driving wheels are identical.

4. The cleaning apparatus in accordance with claim 3 characterized in that a pneumatic pressure tank is installed inside the apparatus, which serves as a buffer for fast reactions of pneumatic cylinders, which spread the pressure wheel.

5. The cleaning apparatus in accordance with claim 4 characterized in that the pneumatic supply consists of only two pressure hoses for an external control of the travel speed of the spray nozzles in a tangential direction, and for feeding the pressure tank.

6. The cleaning apparatus in accordance with claim 1 characterized in that each worm gear of the worm gears associated with a driving wheel of an enlarged apparatus for larger pipe diameters is identical with those of the basic apparatus.

7. The cleaning apparatus in accordance with claim 6 characterized in that each worm gear of the worm gears associated with a driving wheel is driven by an additional expansion drive shaft using longer roller chains.

8. The cleaning apparatus in accordance with claim 7, characterized in that the apparatus has a flange at the hollow shaft for a connecting flange, bearing a radially expandable structure for two opposite nozzles, whereby a small guiding wheel is guided in a first radial plane by an exterior structure and pressed by a spring against the wall of the pipe, whereas an inner supporting lever of the connecting flange allows radial expansion of the exterior structure with the guiding wheel, and in that a flow of the pressurized liquid is guided in a second parallel radial plane, whereby the flow starts at a blind hole of the connecting flange and ends at a nozzle of the two opposite nozzle, which is connected close to the guiding wheel at a predetermined distance to the pipe wall.

9. The cleaning apparatus in accordance with claim 8, characterized in that the transfer of the liquid includes two high-pressure hoses between the nozzle and the connecting flange, which hoses are connected by a diverting tube piece diverting the current by an angle γ up to 180°, the diverting tube piece equalizing bending moments at both sides by freely floating in the second radial plane, supported by the torsional stiffness of the high pressure hoses.
